(19) United States
(12) Patent Application Publication
(10) Pub. No.: US 2008/0118904 A1
(43) Pub. Date: May 22, 2008

(54) Birding acoustic feedback learning aid

(76) Inventor: Frederick T. Allen, Salem, SC (US)

Correspondence Address: MCNAIR LAW FIRM, P.A., P.O. BOX 10827, GREENVILLE, SC, 29603-0827, US

(21) Appl. No.: 11/603,763

(22) Filed: Nov. 22, 2006

(51) Int. Cl. G09B 5/04

(52) U.S. Cl. 434/319

(57) ABSTRACT

A system and method for an acoustic feedback recognition and learning aid is disclosed, comprising a hand-held electronic wand for use with an accompanying plurality of coded pictures, which when scanned cause the hand-held wand to play back an associated audio file. The invention is adaptable for many uses as a learning aid, including the sport of birding, language translation, language education, object learning, recognition training, and a variety of other similar objects as discussed herein.

### FIELD OF THE INVENTION

The present invention generally relates to an acoustic feedback recognition and learning aid and, more particularly, to a hand-held electronic wand for use with an accompanying plurality of coded pictures, which when scanned cause the hand-held wand to play back an associated audio file. The invention is adaptable for many uses as a learning aid, including the sport of birding, language translation, language education, object learning, recognition training, and a variety of other similar uses as discussed herein.

### BACKGROUND OF THE INVENTION

With the sport of birding becoming ever more popular, the demand for a compact, portable recognition and learning aid has increased dramatically. In practice, birders are often faced with the need to identify multiple species from observation of appearance and/or sound. This process primarily involved thumbing through picture books for many generations and has only recently begun to take advantage of advances in modern electronics.

One such electronic device is the popular Birdsong Identiflyer®, which is commonly used to identify select groups of birds. The Identiflyer® uses a variety of insertable SongCards, whereby each SongCard displays up to ten different bird pictures, each of which is associated with an internally stored audio file of the corresponding bird song. Birders must purchase and interchange additional SongCards for use in identifying additional and various species.

Other devices for birding recognition and learning are known in the art but are generally cumbersome in practice. The learning and identification support system disclosed in U.S. Pat. No. 5,059,126 to Kimball offers additional storage capacity, but requires a bulky compact disc player for storage and playback of audio files. Such a system would be difficult to carry and conceal upon one's person while birding in the wild or other remote locations. Birders would thus be hampered by the sheer size and weight of such a system and would find use thereof difficult.

The system disclosed in Kimball, in conjunction with the Identiflyer® systems, reveals that storage capacity is one of the primary drawbacks of prior art devices. Audio files are generally large and require large capacity storage means. A device that uses standard digital signal processing (DSP) can encode (or encrypt, as the case may be) an audio file so that it may be saved in a smaller digital memory space. But such files are limited in dynamic audio range because of the encoding process. On the other hand, a device that uses ADPCM (adaptive differential pulse code modulation) encoding may be used to save and playback difficult-to-reproduce sounds according to their greater dynamic audio range, but such files are correspondingly larger and require more digital memory space.

What is needed is a compact, portable recognition and learning aid with larger storage capacity that is also capable of storing multiple types of audio files using a variety of encoding techniques.

A primary object of the present invention is to provide a compact, portable recognition and learning aid, such as a hand-held wand, for birders that is capable of providing storage of a multiplicity of audio files, stored using a variety of encoding techniques.

Another object of the present invention is to provide such storage capacity in both a fixed internal memory and in a separate interchangeable memory cartridge that integrates seamlessly into a wand's housing. Such a cartridge would also integrate seamlessly with the fixed internal memory so as to expand the device's overall storage capacity.

Yet another object of the present invention is to provide automatic power shutdown of a wand after a pre-selected time interval, where the wand is not in use.

Still another object of the present invention is to provide a method for using a compact, portable recognition and learning aid as described herein. Other objects and benefits of the present invention will become apparent from the detailed description when taken in conjunction with the drawings provided.

### SUMMARY OF THE INVENTION

The present invention accomplishes the foregoing objects by providing a hand-held recognition and learning system and method that is capable of providing storage of a multiplicity of audio files stored with a variety of encoding techniques.

In one aspect of the invention, a system is provided that comprises a unique label displaying information associated with a corresponding audio file stored amongst a multiplicity of stored audio files and a wand for reading the unique label. The system may also comprise a binder for storing the wand and a multiplicity of unique visual or text images, each containing a corresponding unique label. In another aspect of the invention the binder may also include a strap and tether designed to hold the wand in place during transport.

The disclosed wand comprises a computer-readable, first memory for storing a first group of audio files and a computer-readable, second memory for storing a second group of audio files. In another aspect of the invention, the wand may include only a single memory, preferably, the computer-readable, first memory. Where present, the second memory is preferably capable of replacement, seamless integration into the wand's housing, and seamless integration with the first memory to increase the wand's overall storage capacity.

The wand also comprises a scanner for reading the information associated with a corresponding audio file from the unique label and a recognition means for identifying a corresponding audio file based on the associated information. The wand also comprises a file locator for locating the corresponding audio file amongst a first and/or second group of audio files. The wand further comprises a decoder for reading and translating the corresponding audio file into a decoded audio file in playable format. The decoder is capable of decoding a first audio file encoded using a first encoding format and a second audio file encoded using a second encoding format. Moreover, the decoder may be capable of decoding files stored using a variety of different encoding formats. The wand also comprises an audio player for audibly outputting the decoded audio file along with a multiplicity of buttons to control functions, comprising on/off, volume up, volume down, and scanner trigger. Finally, the wand comprises a power supply, such as batteries, for supplying power to the wand.

In another aspect of the invention, a method comprises the steps of providing a hand-held recognition and learning system that is capable of storing a multiplicity of audio files using a variety of encoding techniques. The method further comprises pressing a scanner trigger button on an electronic wand and then bringing the wand in proximity with a unique label. The unique label includes information associated with a corresponding audio file stored amongst a multiplicity of stored audio files. In another aspect of the invention, the wand may read the label in either barcode or magnetic format; so this step could vary from only swiping a barcode to instead only getting sufficiently close to a magnetic label to read its electronic signature.

The method also comprises using a recognition means internal to the wand to identify the corresponding audio file based on associated information. After the recognition means identifies a corresponding audio file, a file locator locates that audio file, which is stored on a first and/or second memory. In one aspect of the invention, the file location step comprises reading audio files from either a first memory that is fixed internal memory, or from a second memory that may be either fixed or interchangeable memory, where the second memory is designed to seamlessly integrate both into the wand's housing and with the first memory. In another aspect of the invention, this step may include reading audio files from only a single internal memory. As such, the method may also include the steps of providing a second memory that is capable of seamlessly integrating with the first memory to expand the wand's overall storage capacity.

Upon location, the method includes using a decoder to read and translate the audio file into a decoded audio file that is playable on the wand's audio player. Once in playable format, the method includes audibly playing the audio file on the electronic wand. If the wand is not used for a pre-determined time interval, the method may also include providing an automatic power shutdown means for automatically shutting down power to the wand.

In yet another aspect of the invention, a method includes providing a binder for storing the wand and a multiplicity of unique visual or text images, each containing a corresponding unique label. While another aspect of the invention comprises the step of providing a strap and tether inside the binder designed to hold the wand in place during transport. Other aspects of the invention will be apparent from the detailed description and discussion of the preferred embodiments with reference to the drawings below.

### DESCRIPTION OF THE DRAWINGS

FIG. 1 is a left side perspective view of an electronic wand according to a preferred embodiment of the invention, wherein a second memory is detached from the wand's housing.

FIG. 2 is a schematic diagram of an electronic circuit for controlling an electronic wand according to a preferred embodiment of the invention.

FIG. 3 is a right side perspective view of an electronic wand according to a preferred embodiment of the invention, wherein a second memory is integrated into the wand's housing.

FIG. 4 is a right side perspective view of an electronic wand according to a preferred embodiment of the invention, wherein a second memory is detached from the wand's housing.

FIG. 5 is an illustration of an electronic wand in combination with a binder containing bird pictures, each with unique labels, according to a preferred embodiment of the invention.

FIG. 6 is a flow chart indicating a method of using an electronic wand according to a preferred embodiment of the invention.

### DESCRIPTION OF THE PREFERRED EMBODIMENTS

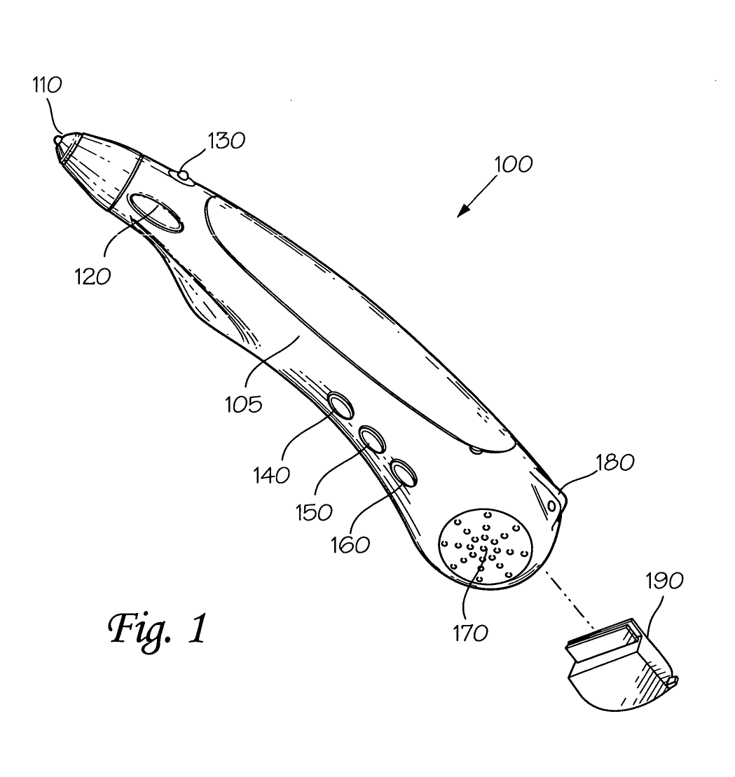

Referring now to the drawings, preferred embodiments of the invention will be described in more detail. As seen in FIG. 1, a preferred embodiment of wand 100 comprises an infrared barcode reader in the form of scanner 110 that is activated when a user presses scanner trigger button 120. In operation, power-on indicator light 130 illuminates when scanner trigger button 120 is pressed and as long as scanner 110 is actively attempting to read a respective barcode. The associated control circuitry inside the wand housing 105 may include a hold period of some pre-determined time to keep the barcode reader in scan mode after trigger button 120 is released. Control buttons 140, 150, and 160 are provided on housing 105 and associated with the control circuitry to control volume up, power on/off, and volume down, respectively. A speaker 170 is carried in housing 105 for playing the audio files stored within the computer-readable memory of wand 100. User strap holder 180 allows users to connect a flexible user strap for stand-alone hand-held use and also allows a user to tether the wand to other carrying means. FIG. 1 further comprises a second memory 190 that is shown detached from the housing 105. This aspect of the invention is discussed in more detail with reference to FIG. 4 below.

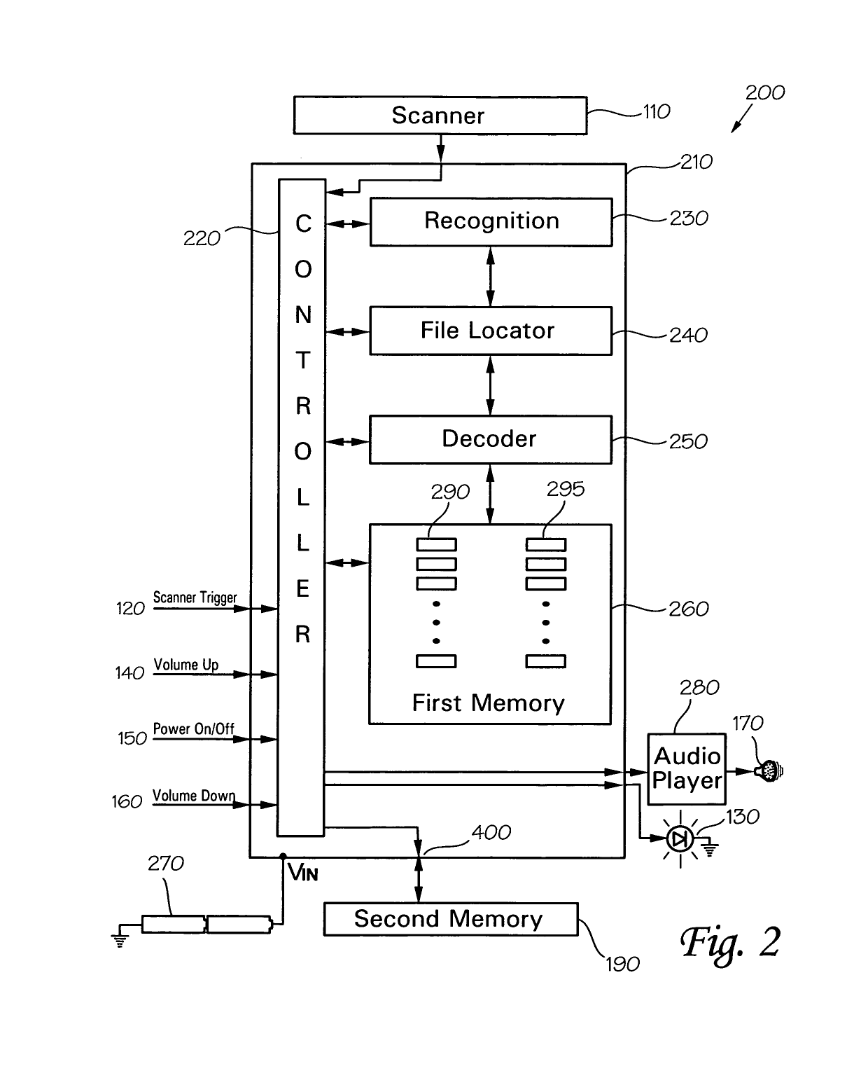

As can best be seen in FIG. 2, the internal circuitry of wand 100 is shown in control circuit 200. Internal DSPIC (digital signal processing integrated circuit) microcontroller 210 is the primary mechanism used to control the various inputs, outputs, and functions of wand 100. DSPIC 210 contains a controller 220 that receives the various inputs from wand 100, processes many of those inputs, and routes others to the correct sub-circuitry for processing.

In a preferred embodiment, controller 220 receives input from scanner 110 and sends that input to recognition circuit 230 in order to verify that the input is a recognized label and to identify a specific key code associated with the label. Recognition circuit 230 then sends the specific key code to file locator 240. That key code is then used by file locator 240 to locate a corresponding audio file 290 or 295 associated with the key code from within computer-readable, first memory 260 or detachable, computer-readable, second memory 190. Once located, audio file 290 or 295 is sent to decoder 250 and converted into playable format.

In addition to the foregoing, FIG. 2 also illustrates other inputs to controller 220. Scanner trigger 120, volume up button 140, power on/off button 150, and volume down button 160 all feed their inputs directly into controller 220. In normal operation, a user presses scanner trigger button 120, which actuates a momentary contact switch. The signal from that switch is fed directly to an associated input for controller 220 to activate recognition circuit 230. The same occurs when a user presses volume up button 140, power on/off button 150, or volume down button 160. In each instance, controller 220 receives the input and processes the correct actions thereafter.

Controller 220 also produces the necessary output signals to operate control circuit 200. When an audio file is located by file locator 240 and decoded by decoder 250, controller 220 sends an appropriate signal to audio player 280 to audibly produce the decoded audio file. When scanner 110 is in use, power-on indicator light 130 is activated by controller 220 as indicated in FIGS. 1 and 2. The necessary voltage to operate control circuit 200 is provided by power supply 270. And detachable, computer-readable, second memory 190 connects to DSPIC 210 using connector 400 as illustrated in FIGS. 2 and 4.

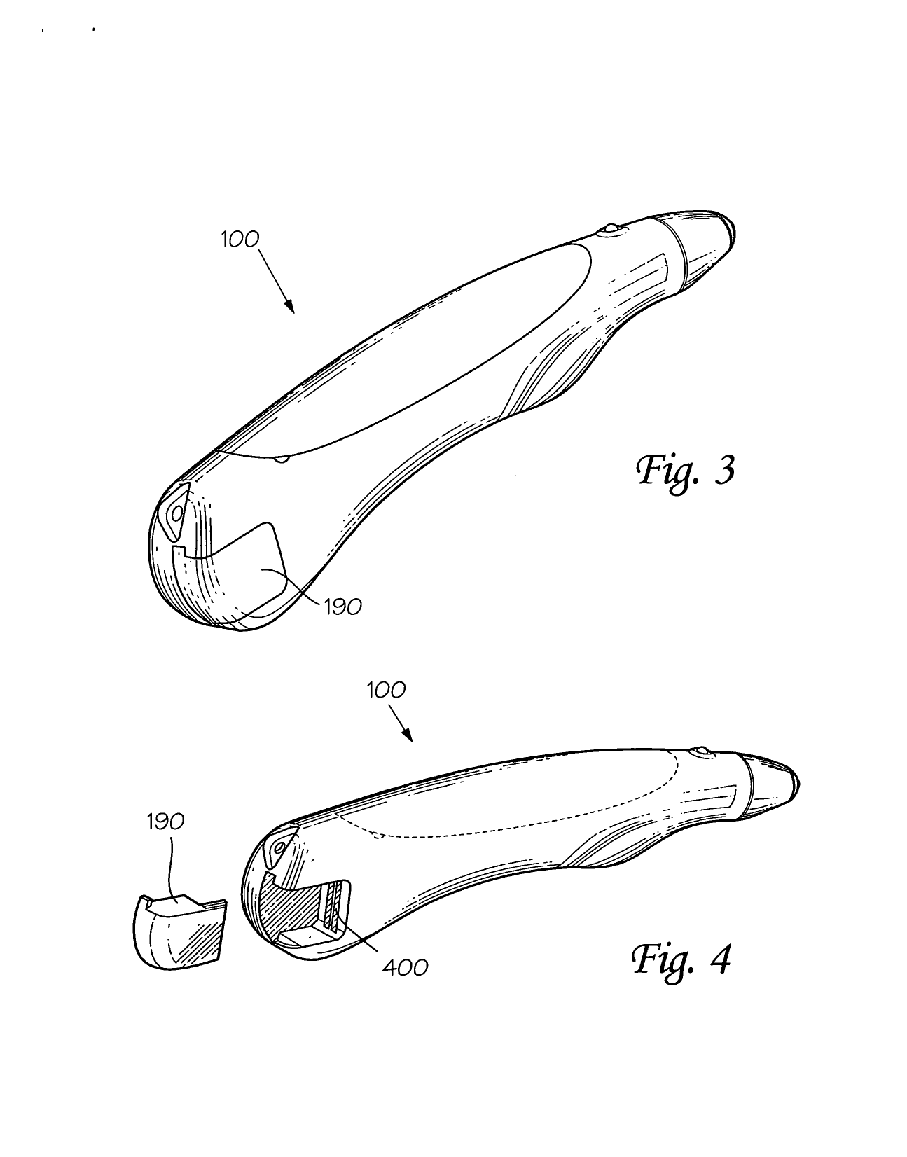

FIG. 3 illustrates a right side perspective view of electronic wand 100 according to a preferred embodiment of the invention, wherein detachable, computer-readable, second memory 190 is integrated into the wand's housing 105. In this preferred embodiment, second memory 190 is seamlessly integrated into the wand's housing 105. Computer-readable, second memory 190 would generally consist of a non-volatile ROM memory cartridge or integrated circuit inserted or molded into a seamless housing 105. Second memory 190 is preferably configured to also seamlessly integrate with a first memory of wand 100, whereby both first memory 260 and second memory 190 combine to increase the overall storage capacity of wand 100.

FIG. 4 illustrates a right side perspective view of electronic wand 100 according to a preferred embodiment of the invention, wherein detachable, computer-readable, second memory 190 is detached from housing 105. Connection terminal 400 is used to connect second memory 190 to housing 105 as illustrated. As further illustrated in FIG. 2, second memory 190 physically connects to control circuit 200 using connector 400. When inserted into housing 105, the male portion of second memory 190 inserts into the female portion of connection terminal 400, thereby connecting second memory 190 to control circuit 200 within housing 105. When control circuit 200 is powered-on and begins its normal startup routine, controller 220 automatically recognizes the addition of second memory 190 and updates its internal value for available memory space to include that of second memory 190. In this manner, second memory 190 is seamlessly integrated into control circuit 200.

As described with reference to FIG. 2, the various functions of wand 100 are controlled by DSPIC 210. In a preferred embodiment, DSPIC 210 has one megabyte or more of internal memory, which is used to store both the controlling firmware of the various sub-circuits and multiple audio files as described above. As such, one of the primary advantages of this preferred embodiment is that a portion of the internal memory of DSPIC 210 is used as the computer-readable, first memory 260 described above.

DSPIC 210 is also capable of decoding internally-stored data encoded with multiple encryption routines. In a preferred embodiment, audio files 290 and 295 are stored in a first memory 260 directly on the internal memory of DSPIC 210 using both DSP (digital signal processing) encoding and using ADPCM (adaptive differential pulse code modulation) encoding. Simpler audio files of moderate frequency sounds are encoded with DSP. More complex audio files of extreme higher and lower frequency sounds (i.e., difficult sounds to reproduce) are encoded using ADPCM. These two files types are illustrated in FIG. 2 as audio file 290, stored using ADPCM, and audio file 295, stored using DSP.

Still other files may be stored with a variety of additional encoding techniques. Overall cost and storage capacity are the primary motivations for using two or more encoding techniques because different encoding formats allow for varying storage capacities; hence, one of the primary advantages of the ability to use multiple encoding formats in this preferred embodiment is that more files can be stored in a smaller memory space. For example, ADPCM files require more storage and processing capability, so ADPCM is used only for difficult-to-produce or higher quality audio files. But DSP encoding, which results in smaller file sizes, is sufficient for many files where sound quality is not as important. As such, in a preferred embodiment, first memory 260 contains both ADPCM- and DSP-encoded files located within a portion of DSPIC 210 internal memory in the form of audio files 290 and 295, respectively. But second memory 190 contains only DSP-encoded files because of the additional processing needed to read audio files from a separate memory cartridge that must also seamlessly integrate with first memory 260.

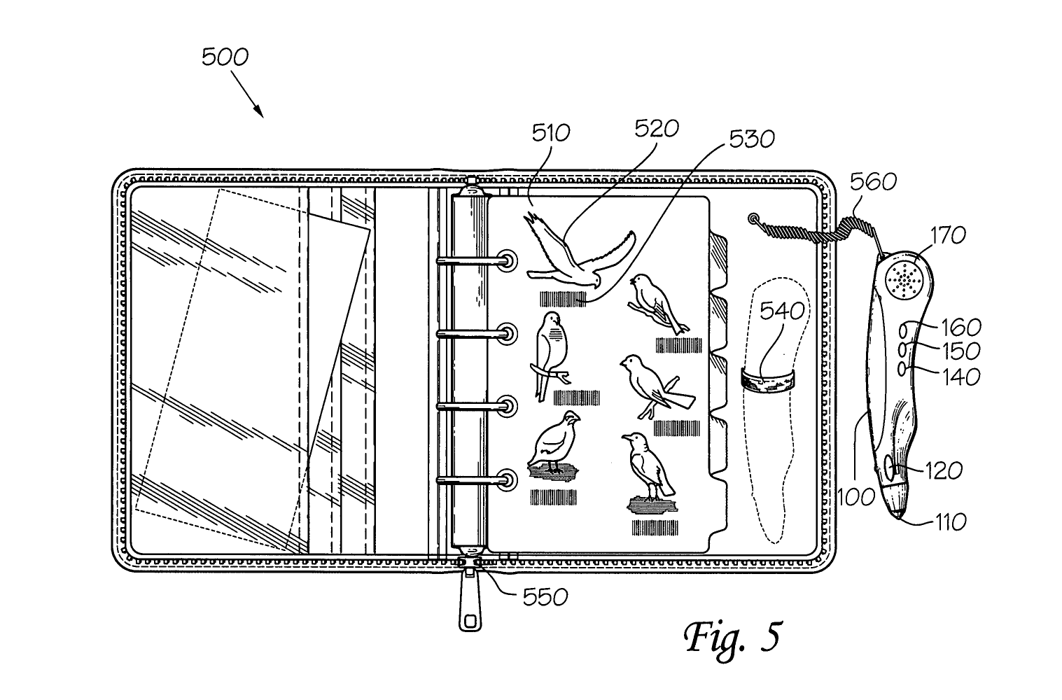

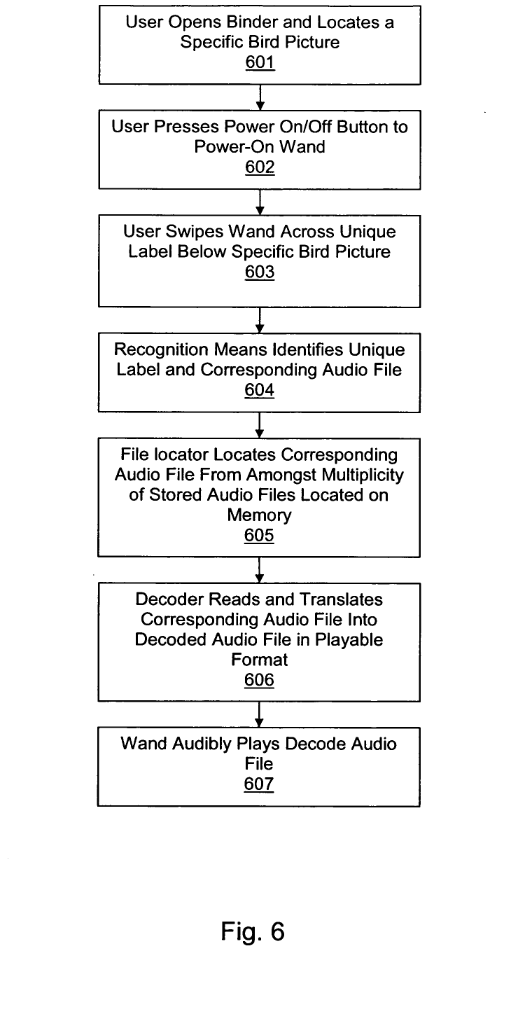

FIG. 5 illustrates an electronic wand 100 in combination with a binder 500 containing multiple pages 510 of bird pictures 520, each with a unique label 530, according to a preferred embodiment of the invention. Binder 500 would normally be closed using zipper 550, wherein wand 100 is enclosed and held in place with strap 540 and tether 560. Operation and use of this preferred embodiment is discussed briefly below and further with reference to the method of FIG. 6.

When a birder wishes to use the system to identify a particular bird or group of birds, the birder opens zipper 550 to reveal the contents of binder 500. The birder would then grasp wand 100 and remove it from strap 540 for use. At that point, the birder would then turn on the power for wand 100 by pressing on/off button 150. Having sighted a particular bird, the birder may then, for example, refer to a specific page 510 of binder 500 to locate a matching bird picture. The birder would then press trigger button 120 of wand 100 and swipe scanner 110 over the corresponding unique label 530, which is generally located below the matching bird. If these actions are performed correctly, wand 100 would then audibly output a recorded birdsong from internal memory using speaker 170.

The birder may choose to repeat these steps for additional confirmation of the bird type or may decide instead to repeat the same steps with a different bird picture 520 and unique label 530. In addition, the birder may choose to increase or decrease the volume of the audible output by pressing volume up and volume down buttons 140 and 160, respectively.

FIG. 6 illustrates a flow chart of an exemplary method of using an electronic wand 100 according to a preferred embodiment of the invention. Moreover, FIGS. 2 and 5 are more fully understood with reference to the steps indicated in the flow chart of FIG. 6, which discloses a method of operating the components of control circuit 200 and binder 500. A birder wishing to utilize the system as a recognition and learning aid may do so according to the indicated steps.

In a typical outing, a birder may at first visually observe a particular bird in an attempt to identify that bird. According to a preferred embodiment of the invention, the birder then opens binder 500 and flips through pages 510 until the specific bird picture 520 is located at step 601. Once located, at step 602 the birder grasps the wand and removes it from strap 540 and presses power on/off button 150 to power-on the wand.

At 603 the birder swipes scanner 110 over the corresponding unique label 530. Recognition circuit 230 and file locator 240 of control circuit 200, then work together to identify unique label 530 and a corresponding audio file 290 or 295 at step 604. This step can be accomplished using a variety of recognition means and methods, such as those described with reference to FIG. 2 above. In addition to those embodiments and techniques, a preferred embodiment of wand 100 may also include any of a variety of standard computer hardware using programming that establishes a specific key code to match each stored audio file with a corresponding unique label. Once the unique label 530 is read and identified, the firmware programming could easily then match that label with its corresponding stored audio file 290 or 295.

Once the corresponding audio file is identified, at 605 a file locator, such as file locator 240 of FIG. 2, then locates that corresponding audio file from amongst a multiplicity of stored audio files 290 or 295, that are located on a computer-readable, first memory 260 or computer-readable, second memory 190. Upon location, the file locator then sends the encoded audio file to decoder 250, which then reads and translates the corresponding audio file into a decoded audio file at step 606, so that it results in an audio file in playable format. The decoded audio file is audibly played at 607 using speaker 170 of wand 100.

These embodiments of the present invention overcome the above-identified and other deficiencies in conventional recognition and learning systems by providing a hand-held recognition and learning system and method that is capable of providing storage of a multiplicity of audio files stored with a variety of encoding techniques.

These examples are offered by way of illustration of the invention's versatility and not meant to limit the invention in any way. The present invention may be embodied in other specific forms without departing from its spirit of essential characteristics. The described embodiments are to be considered in all respects only illustrative and not restrictive. The scope of the invention is, therefore, indicated by the appended claims, rather than by the foregoing description. All changes which come within the meaning and range of equivalency of the claims are to be embraced within their scope.

1. A hand-held recognition and learning system that is capable of providing storage of a multiplicity of audio files stored with a variety of encoding techniques, comprising:
a unique label displaying information associated with a corresponding audio file stored amongst a multiplicity of stored audio files;
a wand comprising:
a housing;
a controller;
a first memory in communication with said controller for storing a first group of said multiplicity of stored audio files;
a second memory in communication with said controller for storing a second group of said multiplicity of stored audio files;
a scanner in communication with said controller for reading said information associated with said corresponding audio file from said unique label;
a recognition circuit in communication with said controller for identifying said corresponding audio file based on said information associated with said corresponding audio file;
a file locator in communication with said controller for locating said corresponding audio file amongst said first and second groups of said multiplicity of stored audio files;
a decoder in communication with said controller for reading and translating said corresponding audio file into a decoded audio file in playable format, said decoder capable of decoding a first audio file encoded using a first encoding format and a second audio file encoded using a second encoding format;
an audio player for audibly outputting said decoded audio file;
a multiplicity of buttons in communication with said controller to control functions, comprising on/off, volume up, volume down, and scanner trigger; and
a power supply for supplying power to said wand.

2. The system of claim 1 wherein said second memory is capable of replacement.

3. The system of claim 1 wherein said second memory is shaped and physically configured to allow seamless integration into said wand's housing.

4. The system of claim 1 wherein said second memory is electronically configured to seamlessly integrate with said first memory to expand said wand's overall storage capacity.

5. The system of claim 1 wherein said wand also comprises automatic power shutdown circuitry to shutdown power to said wand after a pre-selected time interval of non-use.

6. The system of claim 1 also comprising a binder for housing said wand.

7. The system of claim 6 also comprising a multiplicity of unique visual or text images.

8. The system of claim 6 also comprising a multiplicity of said unique labels.

9. The system of claim 6 also comprising a strap and tether designed to hold said wand in place during transport.

10. A hand-held recognition and learning system that is capable of providing storage of a multiplicity of audio files stored with a variety of encoding techniques, comprising:
a unique label displaying information associated with a corresponding audio file stored amongst a multiplicity of stored audio files;
a wand comprising:
a housing;
a controller;
a memory in communication with said controller for storing said multiplicity of stored audio files;
a scanner in communication with said controller for reading said information associated with said corresponding audio file from said unique label;
a recognition circuit in communication with said controller for identifying said corresponding audio file based on said information associated with said corresponding audio file;
a file locator in communication with said controller for locating said corresponding audio file in said multiplicity of stored audio files;
a decoder in communication with said controller for reading and translating said corresponding audio file into a decoded audio file in playable format;
an audio player in communication with said controller for audibly outputting said decoded audio file;
a multiplicity of buttons in communication with said controller to control functions of said wand; and
a power supply for supplying power to said wand.

11. The system of claim 10 also comprising a second memory.

12. The system of claim 10 wherein said second memory is shaped and physically configured to allow seamless integration into said wand's housing.

13. The system of claim 10 wherein said second memory is electronically configured to seamlessly integrate with said first memory to expand said wand's overall storage capacity.

14. The system of claim 10 wherein said wand also comprises automatic power shutdown circuitry to shutdown power to said wand after a pre-selected time interval of non-use.

15. The system of claim 10 also comprising a binder for housing said wand.

16. The system of claim 15 also comprising a multiplicity of unique visual or text images.

17. The system of claim 15 also comprising a multiplicity of said unique labels.

18. The system of claim 15 also comprising a strap and tether designed to hold said wand in place during transport.

19. A method of providing a hand-held recognition and learning system that is capable of storing a multiplicity of audio files using a variety of encoding techniques, said method comprising the steps of:
pressing a scanner trigger button on an electronic wand;
bringing said wand in proximity with a unique label, said label displaying information associated with a corresponding audio file stored amongst a multiplicity of stored audio files;
using a recognition circuit internal to said wand to identify said corresponding audio file based on said information associated with said corresponding audio file;
using a file locator internal to said wand to locate said corresponding audio file stored in said multiplicity of stored audio files on a memory;
using a decoder internal to said wand to read and translate said corresponding audio file into a decoded audio file in playable format; and
audibly playing said corresponding audio file on said electronic wand.

20. The method of claim 19 also including the step of providing a second memory.

21. The method of claim 19 also including the step of providing a second memory that is detachable from said wand.

22. The method of claim 19 also including the step of providing a second memory that is capable of seamlessly integrating into said wand's housing.

23. The method of claim 19 also including the step of providing a second memory that is capable of seamlessly integrating with said first memory to expand said wand's overall storage capacity.

24. The method of claim 19 also including the step of providing an automatic power shutdown means for automatically shutting down power to said wand after a pre-selected time interval of non-use.

25. The method of claim 19 also including the step of providing a binder to store said wand.

26. The method of claim 19 also including the step of providing a multiplicity of unique visual or text images.

27. The method of claim 26 also including the step of providing a multiplicity of said unique labels.

28. The method of claim 26 also including the step of providing a strap and tether designed to hold said wand in place during transport.

29. A hand-held bird recognition and learning system for providing storage and audio playback of a multiplicity of bird call audio files stored with a variety of encoding techniques, comprising:
a hand-held wand having a housing;
human-readable bird display information and coded labels associated with information for a multiplicity of birds;
a controller disposed within said housing;
a first controller-readable memory in communication with said controller for storing a multiplicity of encoded audio files containing bird calls;
a second controller-readable memory in communication with said controller for storing a multiplicity of encoded audio files containing bird calls;
a scanner in communication with said controller for reading said labels and generating a scan signal representing said label;
a file locator in communication with said controller for locating a corresponding encoded audio file from amongst said multiplicity of encoded audio files containing bird calls based on said scan signal;
a decoder in communication with said controller for decoding said corresponding encoded audio file located by said file locator;
an audio player in communication with said controller to reproduce a decoded, playable version of said corresponding encoded audio file;
whereby a large number of bird call audio files may be stored in different formats on said wand and audibly played to reproduce the sound of a bird selected by scanning said wand over said coded labels.
